(19) United States
(12) Patent Application Publication
(10) Pub. No.: US 2002/0171667 A1
(43) Pub. Date: Nov. 21, 2002

(54) Method and apparatus for processing data including an image for presentation on a display

(75) Inventors: John D. Reed, Arlington, TX (US); Jack A. Smith, Bedford, TX (US); Danny Pinckley, Arlington, TX (US)

Correspondence Address: MOTOROLA INC, 5401 NORTH BEACH STREET, MAILSTOP E230, FORT WORTH, TX, 76137

(73) Assignee: MOTOROLA, INC.

(21) Appl. No.: 09/855,388

(22) Filed: May 15, 2001

(51) Int. Cl. G09G 5/00

(52) U.S. Cl. 345/619

(57) ABSTRACT

A processor (804) locates a position for displaying an image on at least one of first and second display portions (202, 204) of a display (200) including a visible seam (206) between the display portions (202, 204). The processor (804) then cooperates with the display (200) to display the image in the position such that, when the position extends beyond one of the display portions (202, 204) and onto a next one of the display portions (202, 204), a portion of the image corresponding to the location of the visible seam (206) is omitted.

### FIELD OF THE INVENTION

This invention relates in general to wireless communication systems, and more specifically to a method and apparatus for processing data including an image for presentation on a display.

### BACKGROUND OF THE INVENTION

Portable communication devices equipped with displays are becoming increasingly popular. Such devices are used for displaying message text as well as images. A trade-off exists between display size (larger is better) and overall device size (smaller is better). A proposed method for increasing display size while maintaining a relatively small device size is the use of a folding display.

A problem with a folding display is that a visible seam exists when the display is opened for use. While construction techniques can be employed to minimize the seam, it is unlikely that the seam will be entirely eliminated. This can cause geometric distortion and/or loss of information, particularly when an image is displayed.

Thus, what is needed is a method and apparatus for processing data including an image for presentation on a display having a first display portion and a second display portion separated by a visible seam. The method and apparatus preferably will arrange the image such that distortion and information loss are minimized.

### BRIEF DESCRIPTION OF THE DRAWINGS

FIG. 1 is an exemplary image to be displayed.

FIG. 2 is an exemplary display having first and second display portions separated by a seam.

FIG. 3 depicts the image displayed on the seamed display using a prior-art data processing technique.

FIG. 4 depicts the image displayed on the seamed display using a data processing technique in accordance with the present invention.

FIGS. 5 and 6 depict the image displayed on the seamed display demonstrating a back and forth movement technique in accordance with the present invention.

FIG. 7 depicts text wrapped to fit into areas of the first and second display portions not used for displaying the image.

FIG. 8 is an exemplary electrical block diagram of an apparatus in accordance with the present invention.

FIG. 9 is an exemplary electrical block diagram of an electronic device in accordance with the present invention.

### DETAILED DESCRIPTION OF THE DRAWINGS

Referring to FIG. 1, an exemplary image 100 to be displayed is depicted. Note that the outer periphery Of the image appears perfectly round.

Referring to FIG. 2, an exemplary display 200 having first and second display portions 202, 204 separated by a visible seam 206 is depicted. The display 200 is preferably a two-section display which folds along the visible seam 206, which is flexible or hinged. It will be appreciated that, while a vertically folding display is depicted, a horizontally folding display can be utilized as well. It will be further appreciated that, alternatively, the display 200 can comprise more than two sections foldably coupled together.

Referring to FIG. 3, the image 100 is displayed on the seamed display 200 using a prior-art data processing technique. Note that the image 100 has been separated into two halves 302, 304, each half displayed on the corresponding display portion 202, 204. Note further that the prior-art data processing technique disadvantageously distorts the image 100, causing the image 100 to appear oblong.

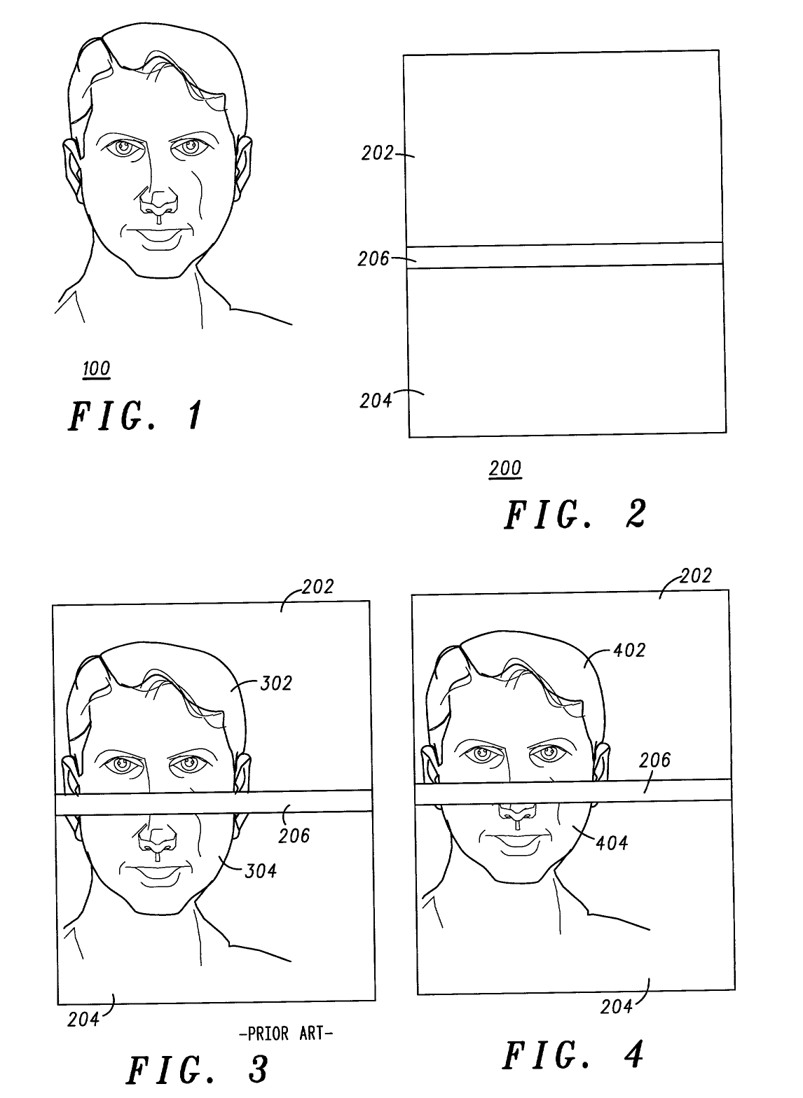

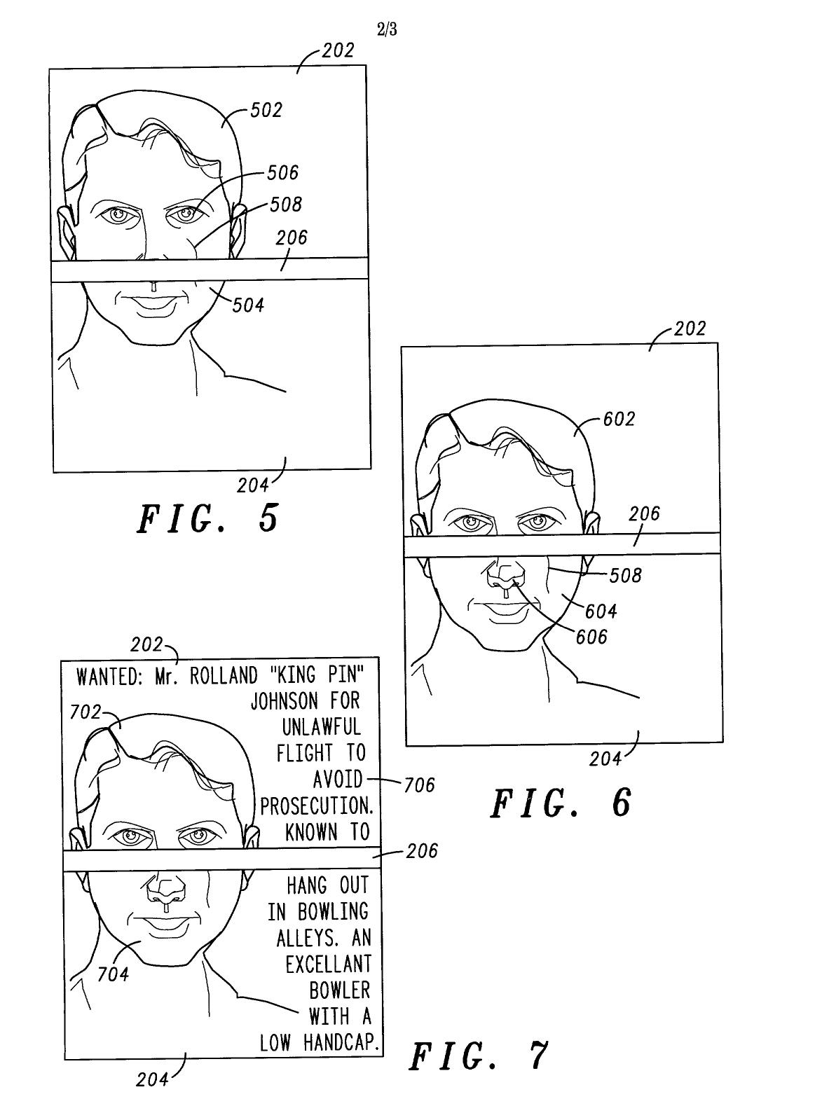

Referring to FIG. 4, the image is displayed on the seamed display 200 using a data processing technique in accordance with the present invention. First, a location on the display 200 is determined for the image. The location takes into consideration the size and aspect ratio of the display 200 as well as that of the image 100. A basic technique is simply to locate the image such that, at an appropriate scale, all parts of the image fall within the boundaries of the display 200. Note that the portion of the image 100 corresponding to the location of the visible seam 206 has been omitted from the image portions 402, 404 displayed on the first and second display portions 202, 204. This advantageously restores the original perfectly round appearance of the image 100.

Referring to FIGS. 5 and 6, the image 100 is displayed on the seamed display 200 demonstrating a back and forth movement technique in accordance with the present invention. While the technique depicted in FIG. 4 restores the original round appearance of the image 100, the image details “under” the visible seam are lost. To restore the lost details, a technique of repeatedly moving the image back and forth perpendicular to the visible seam during a time period, such that the portion of the image corresponding to the position of the visible seam differs with time, advantageously allows the display of the omitted portions of the image during part of the time period. For example, FIG. 5 depicts the image 100 at an uppermost position, showing any details around the eyes, such as the scar 508 beneath the left eye 506, while FIG. 6 depicts the image 100 at an lowermost position, showing details such as the nose 606. The back and forth movement preferably occurs automatically at a slow rate, e.g., 0.5 Hz. It will be appreciated that, alternatively, the image can be moved back and forth perpendicular to the visible seam, in response to a user input, e.g., through a thumb wheel or up-down buttons. It will be further appreciated that the image can be scaled for presentation on a display surface having a size and aspect ratio compatible with the first and second display portions 202, 204 aligned adjacent to one another and separated by more than the width of the visible seam 206. For example, when the image is scaled for presentation on a display surface having a size and aspect ratio compatible with the first and second display portions 202, 204 aligned adjacent to one another and separated by twice the width of the visible seam 206, the image advantageously can be moved back and forth to reveal that which is “under” the visible seam 206 without introducing a “black bar” either above or below the image.

Referring to FIG. 7, text 706 is wrapped to fit into areas of the first and second display portions 202, 204 not used for displaying the image 100. In the case of text, no data is omitted. Instead, all of the text data is displayed and “wrapped” from the first display portion 202 to the second display portion 204 and around the image 100, as illustrated.

Several variations and enhancements can be made to the technique in accordance with the present invention. For example, the image 100 can be processed further to identify predetermined important features, e.g., eyes, nose, mouth, of the image, through well-known techniques. Then, the image 100 can be located such that, to the extent possible, the predetermined important features do not fall within the portion of the image corresponding to the position of the visible seam 206. Alternatively, when the image 100 does not require the full resolution of the display 200, the image 100 can be positioned wholly in one of the first and second display portions 202, 204, freeing the remaining display portion for displaying text or other information. In addition, in more sophisticated systems, the data can include conventional attributes for controlling scaling and placement of the image 100 on the display 200 and identifying important areas of the image. Then the image 100 can be positioned such that the important areas are protected in accordance with the attributes, i.e., the important areas are kept away from the visible seam 206.

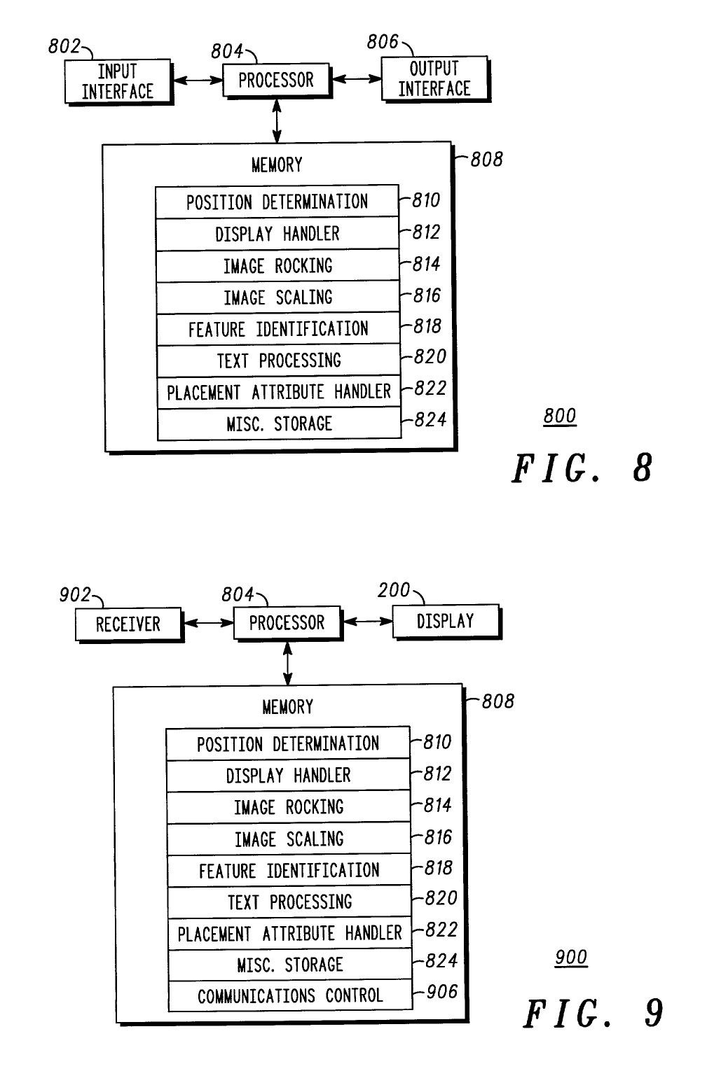

FIG. 8 is an exemplary electrical block diagram of an apparatus 800 in accordance with the present invention. The apparatus can, for example, represent a module for use in an electronic device. The apparatus 800 comprises an input interface 802 for accepting data from an external source, and a processor 804 coupled to the input interface 802 for processing the data. The apparatus 800 also includes an output interface 806 coupled to the processor 804 for outputting the processed data, and a memory 808 for storing software and operating variables utilized in accordance with the present invention.

The memory 808 comprises a position determination program 810 for programming the processor 804 to determine a location of a position on at least one of first and second display portions compatible with a display for displaying the image. The memory 808 further comprises a display handler program 812 for programming the processor 804 to process the data for displaying the image in the position such that, when the position extends beyond one of the display portions and onto a next one of the display portions, a portion of the image corresponding to the location of the visible seam is omitted. In addition, the memory 808 includes an image rocking program 814 for programming the processor 804 to repeatedly move the image back and forth perpendicular to the visible seam during a time period, such that the portion of the image corresponding to the position of the visible seam differs with time, thereby allowing a display of potentially omitted portions of the image during part of the time period. The memory 808 also includes an image scaling program 816 for programming the processor 804 to scale the image for presentation on a display surface having a size and aspect ratio compatible with the first and second display portions aligned adjacent to one another and separated by more than the width of the visible seam.

The memory 808 further comprises a feature identification program 818 for programming the processor 804 to process the image through well-known techniques to identify predetermined important features of the image; and to locate the image such that the predetermined important features do not fall within the portion of the image corresponding to the position of the visible seam. The memory 808 also includes a text processing program 820 for programming the processor 804 to wrap text to fit into areas of the first and second display portions not used for displaying the image. In addition, the memory 808 includes a placement attribute handler program 822 for programming the processor 804 to scale and locate the image and protect important areas in accordance with attributes included in the data for controlling placement of the image on the display and identifying the important areas of the image. The memory 808 also includes a miscellaneous storage area 824 for storing miscellaneous variables used in accordance with the present invention.

FIG. 9 is an exemplary electrical block diagram of an electronic device 900 in accordance with the present invention. The electronic device 900 can be, for example, a selective call receiver or a cell phone. The electronic device 900 is similar to the apparatus 800, the essential differences being the replacement of the input interface 802 with the receiver 902 for communicating with an external device, the replacement of the output interface 806 with the display 200, and the addition of a communications control program 906 for programming the processor 804 to control the communications of the electronic device 900 in accordance with the present invention.

It should be clear from the preceding disclosure that the present invention provides a method and apparatus for processing data including an image for presentation on a display having a first display portion and a second display portion separated by a visible seam. The method and apparatus advantageously arranges the image such that distortion and information loss are minimized.

Many modifications and variations of the present invention are possible in light of the above teachings. Thus, it is to be understood that, within the scope of the appended claims, the invention can be practiced other than as specifically described herein above.

What is claimed is:

1. A method for processing data including an image for presentation on a display having a first display portion and a second display portion, the first and second display portions separated by a visible seam having a location and a width, the method comprising the steps of:
locating a position on at least one of the first and second display portions for displaying the image; and
displaying the image in said position such that, when said position extends beyond one of the display portions and onto a next one of the display portions, a portion of the image corresponding to the location of the visible seam is omitted.

2. The method of claim 1, wherein the locating step comprises the step of repeatedly moving the image back and forth perpendicular to the visible seam during a time period, such that the portion of the image corresponding to the position of the visible seam differs with time, thereby allowing a display of potentially omitted portions of the image during part of the time period.

3. The method of claim 1, wherein the locating step comprises the step of moving the image back and forth perpendicular to the visible seam, in response to a user input through a user interface.

4. The method of claim 1, wherein the displaying step comprises the step of scaling the image for presentation on a display surface having a size and aspect ratio compatible with the first and second display portions aligned adjacent to one another and separated by more than the width of the visible seam.

5. The method of claim 1, wherein the locating step further comprises the steps of:
processing the image to identify predetermined important features of the image; and
locating the image such that the predetermined important features do not fall within the portion of the image corresponding to the position of the visible seam.

6. The method of claim 1, wherein the locating step comprises the step of positioning the image wholly in one of the first and second display portions.

7. The method of claim 1,
wherein the data also includes text, and
wherein the method further includes the step of wrapping the text to fit into areas of the first and second display portions not used for displaying the image.

8. The method of claim 1,
wherein the data includes attributes for controlling at least one of scaling and placement of the image on the display and identifying important areas of the image, and
wherein the locating step comprises the step of scaling and locating the image and protecting the important areas in accordance with the attributes.

9. An apparatus for processing data including an image for presentation on a display having a first display portion and a second display portion, the first and second display portions separated by a visible seam having a location and a width, the apparatus comprising:
an input interface for accepting the data;
a processor coupled to the input interface for processing the data; and
an output interface coupled to the processor for outputting the processed data,
wherein the processor is programmed to:
determine a location of a position on at least one of the first and second display portions for displaying the image; and
process the data for displaying the image in said position such that, when said position extends beyond one of the display portions and onto a next one of the display portions, a portion of the image corresponding to the location of the visible seam is omitted.

10. The apparatus of claim 9, wherein the processor is further programmed to repeatedly move the image back and forth perpendicular to the visible seam during a time period, such that the portion of the image corresponding to the position of the visible seam differs with time, thereby allowing a display of potentially omitted portions of the image during part of the time period.

11. The apparatus of claim 9, wherein the processor is further programmed to scale the image for presentation on a display surface having a size and aspect ratio compatible with the first and second display portions aligned adjacent to one another and separated by more than the width of the visible seam.

12. The apparatus of claim 9, wherein the processor is further programmed to:
process the image to identify predetermined important features of the image; and
locate the image such that the predetermined important features do not fall within the portion of the image corresponding to the position of the visible seam.

13. The apparatus of claim 9,
wherein the data also includes text, and
wherein the processor is further programmed to wrap the text to fit into areas of the first and second display portions not used for displaying the image.

14. The apparatus of claim 9,
wherein the data includes attributes for controlling at least one of scaling and placement of the image on the display and identifying important areas of the image, and
wherein the processor is further programmed to scale and locate the image and protect the important areas in accordance with the attributes.

15. A electronic device for processing data including an image, comprising:
an input interface for accepting the data;
a processor coupled to the input interface for processing the data; and
a display coupled to the processor for displaying the processed data, the display having a first display portion and a second display portion, the first and second display portions separated by a visible seam having a location and a width;
wherein the processor is programmed to:
determine a location of a position on at least one of the first and second display portions for displaying the image; and
process the data for displaying the image in said position such that, when said position extends beyond one of the display portions and onto a next one of the display portions, a portion of the image corresponding to the location of the visible seam is omitted.

16. The electronic device of claim 15, wherein the processor is further programmed to repeatedly move the image back and forth perpendicular to the visible seam during a time period, such that the portion of the image corresponding to the position of the visible seam differs with time, thereby allowing a display of potentially omitted portions of the image during part of the time period.

17. The electronic device of claim 15, wherein the processor is further programmed to scale the image for presentation on a display surface having a size and aspect ratio compatible with the first and second display portions aligned adjacent to one another and separated by more than the width of the visible seam.

18. The electronic device of claim 15, wherein the processor is further programmed to:
process the image to identify predetermined important features of the image; and
locate the image such that the predetermined important features do not fall within the portion of the image corresponding to the position of the visible seam.

19. The electronic device of claim 15,
wherein the data also includes text, and
wherein the processor is further programmed to wrap the text to fit into areas of the first and second display portions not used for displaying the image.

20. The electronic device of claim 15,
wherein the data includes attributes for controlling placement of the image on the display and identifying important areas of the image, and
wherein the processor is further programmed to locate the image and protect the important areas in accordance with the attributes.
